(19) United States
(12) Patent Application Publication
(10) Pub. No.: US 2003/0181283 A1
(43) Pub. Date: Sep. 25, 2003

(54) Planet-gear unit for a multistep speed reducer

(76) Inventor: Tai-Shan Chen, Hsin Chuang City (TW)

Correspondence Address: Jones, Tullar & Cooper, P.C., Suite 1002, 2001 Jefferson Davis Highway, Arlington, VA, 22202, US

(21) Appl. No.: 10/101,110

(22) Filed: Mar. 20, 2002

(51) Int. Cl. F16H 57/08

(52) U.S. Cl. 475/331

(57) ABSTRACT

A planet-gear unit for a multistep speed reducer includes a rotary cylindrical carrier having a central gear extending forward from a front end thereof and a central opening defining in a back end thereof. The cylindrical carrier has a plurality of equidistant axial slots in communication with the central opening, and each of the slots is defined tangentially by partitions and axially by a front endwall and a back endwall. Each back endwall defines a bore open to the slot while the front endwall defines a through-hole aligned with the bore. Received in the slots is a plurality of planetary gears, each provided with a rotary spindle having two ends received in the bore and the through-hole. Furthermore, each through-hole is surrounded by a corresponding collar which is peened to narrow the through-hole, thereby confining the spindle in the bore and the through-hole.

### BACKGROUND OF THE INVENTION

1. Field of the Invention

The present invention relates to a planet-gear unit for a multistep speed reducer and, more particularly, to a planet-gear unit which is free of excessive noise in operation and facilitates the final assembly of the multistep speed reducer.

2. Description of Related Art

Multistep speed reducers are widely used in rotary-door actuating devices. As illustrated in FIG. 4, such an actuating device typically includes a rotary outer tube (55) having two ends (57, 51A) rotatably supported by a pair of spaced brackets (50), in order to roll up or down a door (not shown).

In the outer tube (55) there is a stationary inner tube (54) that houses a door counter (51), a motor (52) and a multistep speed reducer (53). Because the speed reducer (53) has a wheel (56) connected to the outer tube (55) by a rivet (58), the outer tube (55) will rotate whenever the wheel (56) is driven by the motor (52), through the speed reducer (53). Therefore, the door is rolled up or down and its displacement is countered or controlled by the door counter (51).

Referring to FIG. 5, the configuration of the multistep speed reducer is now to be described.

In detail, it includes a stationary tubular inner gear (60) having a toothed inner periphery (61). Situated in the inner gear (60) are two or more planet-gear units, each having a rotary carrier (62) with a central gear (63) extending forward from a front end thereof and a plurality of cantilevered spindles (64) extending backward from a back end thereof.

Each unit further includes a plurality of planetary gears (65) mounted around the spindles (64). These planetary gears (65) all mesh with the toothed inner periphery (61) of the stationary inner gear (60) and with the central gear (63) of the next upstream unit. The planetary gears (65) of the utmost upstream unit are driven by a driving gear (not shown) which is in turn driven by the motor (52).

In this configuration, the planetary gears (65) of the utmost upstream unit are revolved both around their spindles (64) and around the axis of the inner gear (60) when the above-mentioned driving gear is rotated by the motor (52), as can be appreciated by those skilled in the art.

The revolution of the planetary gears (65) then turns the associated carrier (62) as well as the associated central gear (63), which in turn revolves the planetary gears (65) of the next downstream unit. Finally, the central gear (63) of the utmost downstream unit is turned and so is the wheel (56) connected thereto, at a rotational speed quite reduced, in comparison with that of the motor (52), in a step by step way among the units.

However, a problem arises that the conventional speed reducer may operate improperly, since the planetary gears (65) are mounted around cantilevered spindles (64), which may be slightly bent in operation. As a result, the planetary gears (65) may mesh improperly with the inner gear (60) and with the central gear (63) of the next unit, making terrible noises during their operation.

Additionally, the conventional speed reducer is not easy to be assembled because one or more planetary gears (65) tend to separate from the spindles (64) as the carrier (62) with the gears (65) is being put into the tubular inner gear (60).

Therefore, it is an objective of the invention to provide a planet-gear unit for a multistep speed reducer to mitigate and/or obviate the aforementioned problems.

### SUMMARY OF THE INVENTION

The object of the present invention is to provide a planet-gear unit which is free of excessive noise in operation.

Another object of the present invention is to provide a planet-gear unit which facilitates the final assembly of a related multistep speed reducer.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a preferred embodiment of a planet-gear unit in accordance with the present invention for a multistep speed reducer;

FIG. 2 is a fragmentary cross-sectional view of the planet-gear unit of FIG. 1;

FIG. 3 is a fragmentary cross-sectional view of a sub-embodiment of the planet-gear unit of FIG. 1;

FIG. 4 is a schematic view of a conventional rotary-door actuating device; and

FIG. 5 is an enlarged exploded perspective view of a conventional multistep speed reducer used in the rotary-door actuating device of FIG. 4.

### DETAILED DESCRIPTION OF THE PREFERRED EMBODIMENT

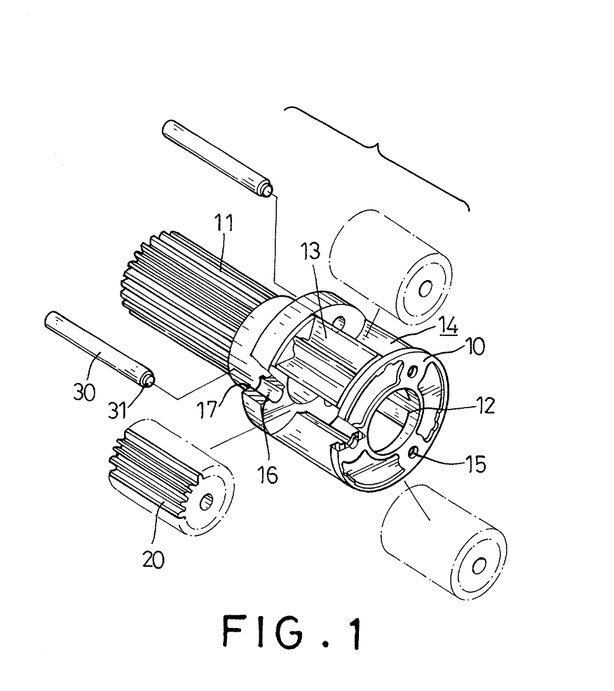

Referring to FIG. 1, there is shown a planet-gear unit in accordance with the present invention for a multistep speed reducer. The planet-gear unit includes a rotary cylindrical carrier (10) having a front end and a back end, with a central gear (11) extending forward from the front end and a central opening (12) defining in the back end.

The cylindrical carrier (10) further has a periphery defining a plurality of equidistant axial slots (14) in communication with the central opening (12) for receiving a plurality of planetary gears (20), which are designed to mesh with the central gear (11) of the next planet-gear unit, as in the prior art.

In detail, each of the slots (14) is defined in the periphery tangentially by partitions (13) formed between the slots (14) and axially by a front endwall (not numbered) and a back endwall (not numbered).

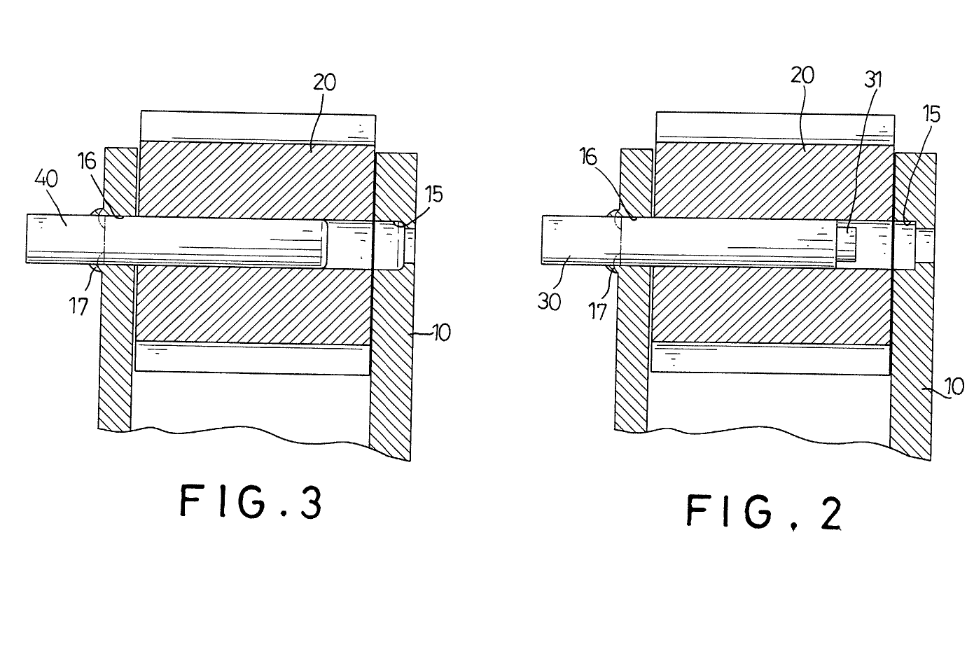

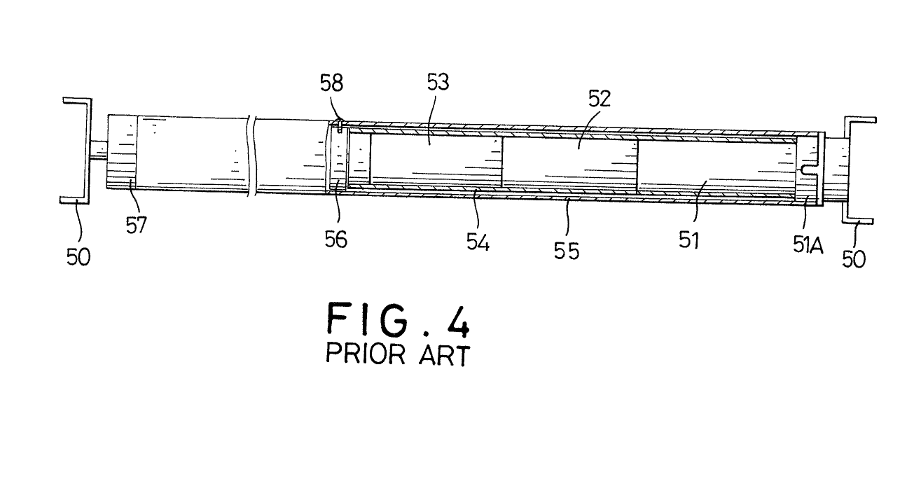

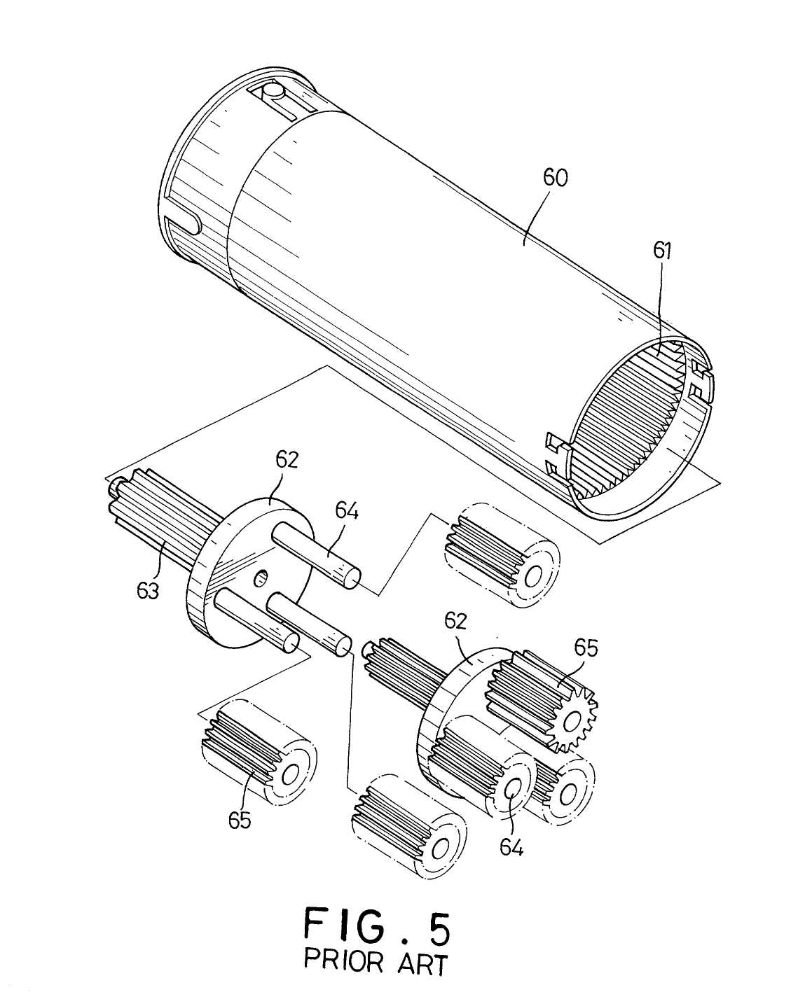

Referring to FIG. 2, each back endwall additionally defines a bore (15) in a stepped configuration having a large-diameter section open to the axial slot (14) and a small-diameter section open to the back end of the cylindrical carrier (10), and the related front endwall defines a through-hole (16) opposed to and aligned with the bore (15) of the back end wall.

Each of the planetary gears (20) is provided with a rotary spindle (30) having a stepped first end and a second end. The stepped first end, formed with a stub (31) thereon, may be extended through the planet gear (20) as well as the through-hole (16), until being received in the large-diameter section of the bore (15) with the stub (31) in the small-diameter section. The second end of the spindle (30) is then received in the through-hole (16) of the front end wall.

Alternatively, each of the planetary gears (20) may be provided with a rotary spindle (40) having a plain first end and a second end, as shown in FIG. 3, with the plain first end received in the large-diameter section of the bore (15) and the second end received in the through-hole (16).

Referring to FIGS. 2 and 3, irrespective to the alternative configurations of the first ends of the spindles (30, 40), each of the through-holes (16) is surrounded by a corresponding collar (17) that projects forward from the front end of the cylindrical carrier (10).

As shown in dash-lines, the collar (17) is finally peened to narrow the through-hole (16) at the front end of the cylindrical carrier (10), thereby confining the spindle (30, 40) in the bore (15) and the through-hole (16) and hence the planetary gear (20) in the axial slot (14).

From the above description, it is noted that the invention has the following advantages:

1. being free of excessive noises:

Because the spindles (30) are each supported at two ends, they will always properly mesh with the central gear (11) of the next planet-gear unit, being free of excessive noises.

2. facilitating final assembly of the multistep speed reducer:

Because each inventive unit has been assembled properly, the final assembly can easily be carried out without possibility of any planet gear (30) going out of the carrier (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A planet-gear unit for a multistep speed reducer, comprising:
a rotary cylindrical carrier (10) having a front end and a back end, said cylindrical carrier (10) being formed with a central gear (11) extending forward from said front end and a central opening (12) defining in said back end;
said cylindrical carrier (10) having a periphery defining a plurality of equidistant axial slots (14) in communication with said central opening (12);
each of said axial slots (14) being defined in said periphery tangentially by partitions (13) formed between said slots (14) and axially by a front endwall and a back endwall;
said back endwall defining a bore (15) open to said slot (14), said front endwall defining a through-hole (16) opposed to and aligned with said bore (15);
a plurality of planetary gears (20) received in said axial slots (14) of said carrier (10), each of said planetary gears (20) being provided with a rotary spindle (30) having a first end received in said bore (15) of said back endwall and a second end received in said through-hole (16) of said front end wall; and
wherein each through-hole (16) is surrounded by a corresponding collar (17) projecting forward from said front end of said cylindrical carrier (10), and said collar (17) is deformed to narrow said through-hole (16) at said front end of said cylindrical carrier (10), thereby confining said spindle (30) in said bore (15) and said through-hole (16) and hence said planetary gear (20) in said axial slot (14).

2. The planet-gear unit as claimed in claim 1, wherein each of said bores (15) is made into a stepped configuration having a large-diameter section open to said axial slot (14) and a small-diameter section open to said back end of said cylindrical carrier (10).

3. The planet-gear unit as claimed in claim 2, wherein each rotary spindle (30) has a stepped first end with a stub (31), and wherein said first end of said rotary spindle (30) is received in said large-diameter section of said bore (15) with said stub (31) accommodated in said small-diameter section.

4. The planet-gear unit as claimed in claim 2, wherein each rotary spindle (30) has a plain first end received in said large-diameter section of said bore (15).
